(19) United States
(12) Patent Application Publication
(10) Pub. No.: US 2025/0341334 A1
(43) Pub. Date: Nov. 6, 2025

(54) AIR CONDITIONING COORDINATION SYSTEM, AND CONTROL DEVICE

(71) Applicant: DAIKIN INDUSTRIES, LTD., Osaka-shi, Osaka (JP)

(72) Inventor: Naotoshi FUJITA, Osaka-shi (JP)

(73) Assignee: DAIKIN INDUSTRIES, LTD., Osaka-shi, Osaka (JP)

(21) Appl. No.: 18/869,794

(22) PCT Filed: Mar. 31, 2023
(86) PCT No.: PCT/JP2023/013677

§ 371 Date: Nov. 26, 2024

(30) Foreign Application Priority Data
May 31, 2022 (JP) 2022-088844

(51) Int. Cl. F24F 11/77; F24F 8/95; F24F 11/46; F24F 110/10; F24F 110/20; F24F 110/64; F24F 110/70

(52) U.S. Cl. CPC F24F 11/77; F24F 8/95; F24F 11/46; F24F 2110/10; F24F 2110/20; F24F 2110/64; F24F 2110/70

(57) ABSTRACT

An air conditioning coordination system includes: an outside air introducing machine for adjusting a target state quantity of the target space by introducing outside air; an air treating machine including a treatment unit for adjusting the target state quantity by treating the air; a control unit for setting a first airflow rate of the outside air introducing machine and a second airflow rate of the air treating machine; and a storage unit for storing relationship information representing a relationship between a selected state quantity, the first airflow rate, and the second airflow rate. The selected state quantity is a state quantity of the target space different from the target state quantity and is changed using at least one of the outside air introducing machine and the air treating machine. The control unit sets the first and second airflow rates from the relationship information based on the selected state quantity.

### TECHNICAL FIELD

The present disclosure relates to an air conditioning coordination system and a control device.

### BACKGROUND

Ventilation devices and air conditioners are installed in a target space to enhance its comfort. To reduce the concentration of a target substance (hazardous substance or pathogen) to less than or equal to a certain criterion, a certain amount of ventilation is required.

For energy savings, ventilation systems that reduce energy consumption have been proposed (for example, Patent Literature 1).

### CITATION LIST

### Patent Literature

Patent Literature 1: Japanese Laid-Open Patent Publication No. 2013-92267

### SUMMARY OF INVENTION

### Technical Problem

However, in conventional systems, the ventilation device and air conditioner each operate under their own independent control. In a case in which the concentration of a target substance in the target space is reduced to less than or equal to the criterion, if each device operates independently to satisfy this condition, there is a risk that, from the perspective of the overall system, they may operate more than necessary to achieve the condition. This issue is not limited to cases in which the concentration of a target substance is reduced to a level less than or equal to the criterion. Thus, for energy savings, there is room for improvement in the operation of these devices.

### Solution to Problem

An air conditioning coordination system according to a first aspect that solves this problem adjusts an air state of a target space. The air conditioning coordination system includes an outside air drawing device that adjusts a target state quantity of the target space by drawing outside air into the target space, an air treatment device including a treatment unit that adjusts the target state quantity by treating air in the target space, a controller that sets a first airflow rate for the outside air drawing device and a second airflow rate for the air treatment device, and a memory that stores relational information indicating a relationship between the first airflow rate, the second airflow rate, and a selected state quantity. The selected state quantity is a state quantity of the target space that is different from the target state quantity and is changed by at least one of the outside air drawing device and the air treatment device. The controller sets the first airflow rate and the second airflow rate from the relational information based on the selected state quantity. The first airflow rate is a flow rate of air that is drawn into the target space by the outside air drawing device. The second airflow rate is a flow rate of air treated by the air treatment device.

In this configuration, when the target state quantity in the target space is adjusted, more energy is saved compared to when the outside air drawing device and the air treatment device operate independently.

In a second aspect of the air conditioning coordination system, the air conditioning coordination system according to the first aspect has the following configuration. The selected state quantity includes a first selected state quantity that is changed by the outside air drawing device. The relational information includes first derivation information used to derive the first airflow rate based on the first selected state quantity and second derivation information used to derive the second airflow rate based on the first airflow rate.

This configuration allows the first airflow rate to be set based on the first selected state quantity. This configuration also allows the second airflow rate to be set based on the first airflow rate.

In a third aspect of the air conditioning coordination system, the air conditioning coordination system according to the second aspect has the following configuration. The controller has an airflow rate range that is set such that the first selected state quantity satisfies a first criterion. The controller sets the first airflow rate to a minimum amount of the airflow rate range set for the first selected state quantity of the target space.

In this configuration, the first airflow rate is set to the minimum amount. Thus, when adjusting the air state of the target space such that the target state quantity is adjusted and the first selected state quantity satisfies the first criterion, the configuration allows for energy savings while limiting the changes in the indoor environment that may occur when outside air is drawn in.

In a fourth aspect of the air conditioning coordination system, the air conditioning coordination system according to the third aspect has the following configuration. The first selected state quantity is a carbon dioxide concentration, temperature, or humidity in the target space.

When adjusting the carbon dioxide concentration, temperature, or humidity by the outside air drawing device, this configuration achieves energy savings while performing air conditioning for the target space to adjust the target state quantity and satisfy the criterion of the carbon dioxide concentration, temperature, or humidity.

In a fifth aspect of the air conditioning coordination system, the air conditioning coordination system according to the second aspect has the following configuration. The air treatment device includes an air purifier including the treatment unit and an air conditioner including the treatment unit and an air conditioning unit that adjusts a temperature in the target space. The second airflow rate includes an airflow rate for the air purifier and an airflow rate for the air conditioner.

When the air purifier and the air conditioner are operating, this configuration allows for adjustment of the total airflow rate for both devices.

In a sixth aspect of the air conditioning coordination system, the air conditioning coordination system according to the first aspect has the following configuration. The selected state quantity includes a second selected state quantity that is removed through air treatment performed by the air treatment device. The relational information includes third derivation information used to derive the second airflow rate based on the second selected state quantity and fourth derivation information used to derive the first airflow rate based on the second airflow rate.

In this configuration, when adjusting the air state of the target space such that the target state quantity is adjusted and the second selected state quantity satisfies a second criterion, energy savings are achieved.

In a seventh aspect of the air conditioning coordination system, the air conditioning coordination system according to the first aspect has the following configuration. The selected state quantity includes a first selected state quantity that is changed by the outside air drawing device. The relational information includes third relational information that indicates a relationship between the first selected state quantity, the first airflow rate, and the second airflow rate. This configuration allows the first airflow rate and the second airflow rate to be derived based on the first selected state quantity and the third relational information.

In an eighth aspect of the air conditioning coordination system, the air conditioning coordination system according to the first aspect has the following configuration. The selected state quantity includes a second selected state quantity that is removed through air treatment performed by the air treatment device. The relational information includes fourth relational information that indicates a relationship between the second selected state quantity, the first airflow rate, and the second airflow rate. This configuration allows the first airflow rate and the second airflow rate to be derived based on the second selected state quantity and the fourth relational information.

In a ninth aspect of the air conditioning coordination system, the air conditioning coordination system according to any one of the first to eighth aspects has the following configuration. The target state quantity is a pathogen concentration, a pollen concentration, a PM concentration, a dust concentration, or a hazardous chemical concentration in the target space. This configuration allows for adjustment of the pathogen concentration, pollen concentration, PM concentration, dust concentration, or hazardous chemical concentration.

A control device according to a tenth aspect that solves the problem controls equipment that adjusts an air state of a target space. The equipment includes an outside air drawing device that adjusts a target state quantity of the target space by drawing outside air into the target space, an air treatment device including a treatment unit that adjusts the target state quantity by treating air in the target space, a controller that sets a first airflow rate for the outside air drawing device and a second airflow rate for the air treatment device, and a memory that stores relational information indicating a relationship between the first airflow rate, the second airflow rate, and a selected state quantity. The selected state quantity is a state quantity of the target space that is different from the target state quantity and is changed by at least one of the outside air drawing device and the air treatment device. The controller sets the first airflow rate and the second airflow rate from the relational information based on the selected state quantity. The first airflow rate is a flow rate of air that is drawn into the target space by the outside air drawing device. The second airflow rate is a flow rate of air treated by the air treatment device.

In this configuration, when the target state quantity in the target space is adjusted, more energy is saved compared to when the outside air drawing device and the air treatment device operate independently.

### Other Aspects

This specification discloses techniques in the following aspects.

An air conditioning coordination system according to a first aspect adjusts an air state of a target space. The air conditioning coordination system includes an outside air drawing device that adjusts a target substance concentration of the target space by drawing outside air into the target space, an air treatment device including a treatment unit that adjusts the target substance concentration by treating air in the target space, and a controller that sets a first airflow rate for the outside air drawing device and a second airflow rate for the air treatment device. The controller refers to a required airflow rate and one of the first airflow rate and the second airflow rate to set the other one of the first airflow rate and the second airflow rate. The required airflow rate is necessary to bring the target substance concentration to an objective concentration. The first airflow rate is a flow rate of air that is drawn into the target space by the outside air drawing device. The second airflow rate is a flow rate of air treated by the air treatment device.

In this configuration, when bringing the target substance concentration closer to the objective concentration, more energy is saved compared to when the outside air drawing device and the air treatment device operate independently.

In a second aspect of the air conditioning coordination system, the air conditioning coordination system according to the first aspect has the following configuration. A state quantity that is different from the target substance concentration and is adjusted by drawing outside air using the outside air drawing device is defined as a first selected state quantity. The controller sets the first airflow rate such that the first selected state quantity of the target space satisfies a first criterion and sets the second airflow rate based on the first airflow rate.

In this configuration, when adjusting the air state of the target space such that the target substance concentration approaches the objective concentration and the first selected state quantity satisfies the first criterion, energy savings are achieved.

In a third aspect of the air conditioning coordination system, the air conditioning coordination system according to the second aspect has the following configuration. The controller has an airflow rate range that is set such that the first selected state quantity satisfies the first criterion. The controller sets the first airflow rate to a minimum amount of the airflow rate range set for the first selected state quantity of the target space.

In this configuration, the first airflow rate is set to the minimum amount. Thus, when adjusting the air state of the target space such that the target substance concentration approaches the objective concentration and the first selected state quantity satisfies the first criterion, the configuration allows for energy savings while limiting the changes in the indoor environment that may occur when outside air is drawn in.

In a fourth aspect of the air conditioning coordination system, the air conditioning coordination system according to the first aspect has the following configuration. A state quantity that is different from the target substance concentration and is removed through air treatment performed by the air treatment device is defined as a second selected state quantity. The controller sets the second airflow rate such that the second selected state quantity of the target space satisfies a second criterion and sets the first airflow rate based on the second airflow rate.

In this configuration, when adjusting the air state of the target space such that the target substance concentration approaches the objective concentration and the second selected state quantity satisfies the second criterion, energy savings are achieved.

In a fifth aspect of the air conditioning coordination system, the air conditioning coordination system according to the second or third aspect has the following configuration. The first selected state quantity is a carbon dioxide concentration in the target space.

When adjusting the carbon dioxide concentration by the outside air drawing device, this configuration allows for energy savings while performing air conditioning for the target space such that the target substance concentration approaches the objective concentration and the carbon dioxide concentration satisfies its criterion.

In a sixth aspect of the air conditioning coordination system, the air conditioning coordination system according to any one of the second, third, and fifth aspect has the following configuration. The air treatment device includes an air purifier including the treatment unit and an air conditioner including the treatment unit and an air conditioning unit that adjusts a temperature in the target space. The second airflow rate includes an airflow rate for the air purifier and an airflow rate for the air conditioner. The first selected state quantity is a carbon dioxide concentration in the target space.

When adjusting the carbon dioxide concentration by the outside air drawing device, this configuration allows for energy savings while performing air conditioning for the target space such that the target substance concentration approaches the objective concentration and the carbon dioxide concentration satisfies its criterion.

In a seventh aspect of the air conditioning coordination system, the air conditioning coordination system according to the sixth aspect has the following configuration. An airflow rate treated by the treatment unit in the air purifier is defined as a third airflow rate. An airflow rate treated by the air conditioning unit and the treatment unit in the air conditioner and set based on a temperature in the target space is defined as a fourth airflow rate. The controller sets the third airflow rate based on the second airflow rate and the fourth airflow rate.

In this configuration, with regard to airflow rate, the operation of the air purifier is coordinated with the operation of the air conditioner. Thus, more energy is saved compared to when such coordination is not performed.

In an eighth aspect of the air conditioning coordination system, the air conditioning coordination system according to any one of the second, third, and fifth to seventh aspect has the following configuration. The first selected state quantity is a temperature or humidity in the target space.

When adjusting the temperature or humidity in the target space by the outside air drawing device, this configuration allows for energy savings while performing air conditioning for the target space such that the target substance concentration approaches the objective concentration and the drawing of outside air allows the temperature or humidity in the target space to satisfy its criterion.

In a ninth aspect of the air conditioning coordination system, the air conditioning coordination system according to the first aspect has the following configuration. When a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption. When a unit amount of air in the target space is treated, an energy consumption of the air treatment device required to treat the unit amount of air is defined as a second energy consumption. The air treatment device includes the treatment unit and an air conditioning unit that adjusts the temperature in the target space. The controller determines whether the first energy consumption is greater than the second energy consumption. When the first energy consumption is greater than the second energy consumption, the controller sets the first airflow rate such that the first energy consumption is less than or equal to a value at a time of determination, and sets the second airflow rate based on the first airflow rate. When the first energy consumption is less than or equal to the second energy consumption, the controller sets the second airflow rate such that the second energy consumption is less than or equal to a value at a time of determination, and sets the first airflow rate based on the second airflow rate.

In this configuration, when the air treatment device performs air conditioning for the target space, the airflow rate is set such that the energy consumption of the device with a higher energy consumption, when comparing the first energy consumption, which is based on the drawing outside air using the outside air drawing device, with the second energy consumption, which is based on air treatment performed by the air treatment device, is made smaller compared to its level at the time of determination. This reduces the total energy consumption, which is the sum of the energy consumption of the outside air drawing device and the energy consumption of the air treatment device.

In a tenth aspect of the air conditioning coordination system, the air conditioning coordination system according to the first aspect has the following configuration. When a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption. When a unit amount of air in the target space is treated, an energy consumption of the air treatment device required to treat the unit amount of air is defined as a second energy consumption. A state quantity that is different from the target substance concentration and is adjusted by drawing the outside air using the outside air drawing device is defined as a first selected state quantity. The controller has a predetermined airflow rate for the outside air drawing device. The predetermined airflow rate is required to ensure that the first selected state quantity satisfies the first criterion in the target space. The air treatment device includes the treatment unit and an air conditioning unit that adjusts the temperature in the target space. When the first energy consumption is greater than the second energy consumption, the controller sets the first airflow rate to be greater than or equal to the predetermined airflow rate such that the first selected state quantity of the target space satisfies the first criterion. Further, the controller sets the second airflow rate based on the first airflow rate.

In some situations, the first selected state quantity, which can be adjusted only by the outside air drawing device, needs to be adjusted and the drawing of outside air by the outside air drawing device in the air conditioning for the target space is disadvantageous in terms of energy consumption. In the above configuration, in such situations, the first airflow rate for the outside air drawing device is set to be greater than or equal to the predetermined airflow rate as described above. This achieves energy savings while performing air conditioning for the target space such that the target substance concentration approaches the objective concentration and the first selected state quantity satisfies the first criterion.

In an eleventh aspect of the air conditioning coordination system, the air conditioning coordination system according to the first aspect has the following configuration. When a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption. When a unit amount of air in the target space is treated, an energy consumption of the air treatment device required to treat the unit amount of air is defined as a second energy consumption. A state quantity that is different from the target substance concentration and is adjustable through air treatment performed by the air treatment device is defined as a second selected state quantity. The controller has a predetermined airflow rate for the air treatment device. The predetermined airflow rate is required to ensure that the second selected state quantity satisfies the second criterion in the target space. The air treatment device includes the treatment unit and an air conditioning unit that adjusts the temperature in the target space. When the first energy consumption is less than or equal to the second energy consumption, the controller sets the second airflow rate to be greater than or equal to the predetermined airflow rate such that the second selected state quantity of the target space satisfies the second criterion. Further, the controller sets the first airflow rate based on the second airflow rate.

In some situations, the second selected state quantity, which can be configured only by the air treatment device, needs to be adjusted and operating the air treatment device in the air conditioning for the target space is disadvantageous in terms of energy consumption. In the above configuration, in such situations, the second airflow rate for the air treatment device is set to be greater than or equal to the predetermined airflow rate as described above. This achieves energy savings while performing air conditioning for the target space such that the target substance concentration approaches the objective concentration and the second selected state quantity satisfies the second criterion.

In a twelfth aspect of the air conditioning coordination system, the air conditioning coordination system according to any one of the first to eleventh aspects has the following configuration. The target substance concentration is a pathogen concentration, a pollen concentration, a PM concentration, a dust concentration, or a hazardous chemical concentration in the target space.

In this configuration, when bringing the pathogen concentration, pollen concentration, PM concentration, dust concentration, or hazardous chemical concentration in the target space closer to the objective concentration, energy savings are achieved.

A control device according to a thirteenth aspect that solves the problem controls equipment that adjusts an air state of a target space. The equipment includes an outside air drawing device that adjusts a target substance concentration of the target space by drawing outside air into the target space and an air treatment device including a treatment unit that adjusts the target substance concentration by treating air in the target space. The control device refers to a required airflow rate and one of a first airflow rate for the outside air drawing device and a second airflow rate for the air treatment device to set the other one of the first airflow rate and the second airflow rate. The required airflow rate is necessary to bring the target substance concentration to an objective concentration. The first airflow rate is a flow rate of air that is drawn into the target space by the outside air drawing device. The second airflow rate is a flow rate of air treated by the air treatment device.

In this configuration, when bringing the target substance concentration closer to the objective concentration, more energy is saved compared to when the outside air drawing device and the air treatment device operate independently.

### BRIEF DESCRIPTION OF DRAWINGS

FIG. 1 is a schematic diagram of an air conditioning coordination system according to a first embodiment.

FIG. 2 is a diagram illustrating the relationship between the required airflow rate, the first airflow rate, and the second airflow rate.

FIG. 3 is a schematic diagram of the air conditioning coordination system according to a second embodiment.

FIG. 4 is a schematic diagram of the air conditioning coordination system according to a third embodiment.

FIG. 5 is a schematic diagram of the air conditioning coordination system according to a fourth embodiment.

FIG. 6 is a diagram illustrating the relationship between the required airflow rate and the first to fourth airflow rates.

FIG. 7 is a schematic diagram of the air conditioning coordination system according to a fifth embodiment.

FIG. 8 is a schematic diagram of the air conditioning coordination system according to a sixth embodiment.

FIG. 9 is a schematic diagram of the air conditioning coordination system according to a seventh embodiment.

FIG. 10 is a schematic diagram of the air conditioning coordination system according to an eighth embodiment.

### DESCRIPTION OF EMBODIMENTS

### First Embodiment

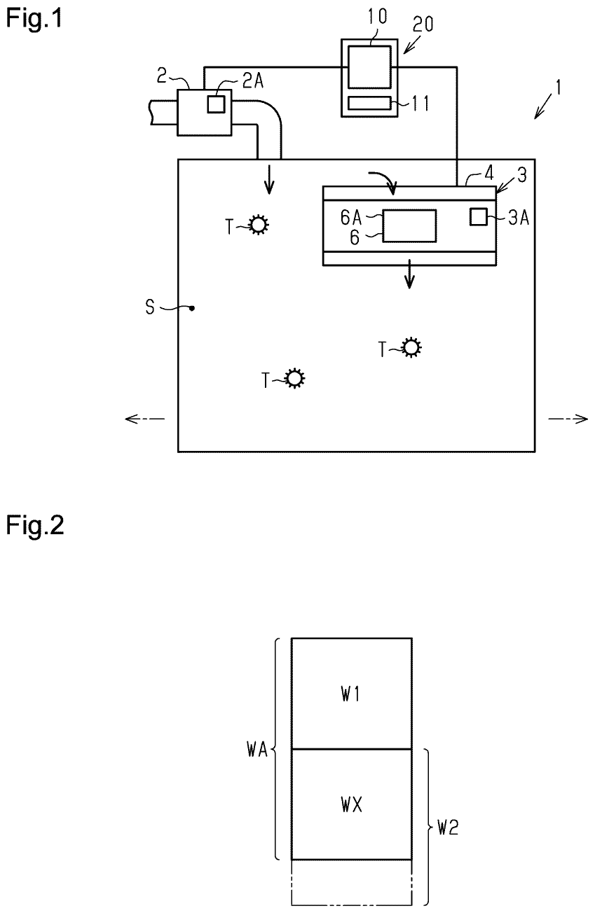

An air conditioning coordination system 1 will now be described with reference to FIG. 1.

The air conditioning coordination system 1 adjusts an air state of a target space S between devices. The air conditioning coordination system 1 adjusts a target state quantity in the target space S through the cooperation of the devices. For example, the target state quantity is a target substance concentration in the target space S. In the following example, the target state quantity is the target substance concentration. In the present embodiment, the air conditioning coordination system 1 adjusts the target substance concentration in the target space S through the cooperation of the devices. The target space S is subject to air conditioning. Examples of the target space S include indoor spaces in buildings, residential indoor spaces, spaces within factories, and spaces within facilities.

Target substances T float in the air. Each target substance T may float in the air and affect a human body. Examples of the target substance T that may be addressed include pathogens, pollen, particulate matter (PM), dust, and harmful chemicals. In the present embodiment, the target substance T in the air conditioning coordination system 1 can be removed from the target space S by either an outside air drawing device 2 or an air treatment device 3, which will be described later. The target substance T in the air conditioning coordination system 1 can vary depending on the configuration of the air conditioning coordination system 1 or the surrounding environment of the target space S. In the air conditioning coordination system 1, the target substance T is set in advance.

Examples of pathogens include coronavirus, influenza virus, rubella virus, rhinovirus, respiratory syncytial virus, adenovirus, and tuberculosis bacterium.

Examples of pollen include cedar pollen, cypress pollen, ragweed pollen, alder pollen, and rice pollen.

Examples of PM include solid particles or liquid particles with a diameter of less than or equal to 10 μm. Solid particles include soot, soil particles, dust from factories, yellow sand, petroleum-related substances, and asbestos particles.

Examples of harmful chemicals include volatile organic compounds. Examples of volatile organic compounds include formaldehyde, acetaldehyde, toluene, xylene, ethylbenzene, styrene, paradichlorobenzene, and chlorpyrifos.

Examples of the target substance concentration is a pathogen concentration, a pollen concentration, a PM concentration, a dust concentration, and a hazardous chemical concentration in the target space S.

### Configuration of Air Conditioning Coordination System

The air conditioning coordination system 1 includes the outside air drawing device 2, the air treatment device 3, and a controller 10. The air conditioning coordination system 1 may include a memory 11. The outside air drawing device 2 adjusts the target substance concentration in the target space S by drawing outside air into the target space S. Examples of the outside air drawing device 2 include a ventilation device and an energy recovery ventilator. The ventilation system may perform first-type ventilation, second-type ventilation, or third-type ventilation. The first-type ventilation uses fans for both air supply and exhaust. The second-type ventilation uses fans for air supply and allows exhaust through gaps or exhaust vents. The third-type ventilation uses fans for exhaust and allows air supply through gaps or intake vents. In first-type ventilation, the airflow rate for outside air intake is defined as the intake airflow rate. In second-type ventilation, the airflow rate for outside air intake is defined as the intake airflow rate. In third-type ventilation, since the exhaust airflow rate can be regarded as equivalent to the intake airflow rate, the airflow rate for outside air intake is defined as the exhaust airflow rate.

The air treatment device 3 includes a treatment unit 6. The treatment unit 6 adjusts the target substance concentration by treating the air in the target space S. The air treatment device 3 draws air in, treats it in the treatment unit 6, and then expels it. The treatment unit 6 removes the target substance T. Examples of the treatment unit 6 include a filter, a UV device, an ionizer device, a virus removal spraying device, and a streamer device.

Examples of the air treatment device 3 include an air conditioner 4 including a treatment unit 6A (hereinafter simply referred to as the air conditioner 4) and an air purifier 5. The air treatment device 3 may include both the air conditioner 4 and the air purifier 5.

The air conditioner 4 treats the target substance T using the treatment unit 6A. Further, the air conditioner 4 adjusts the temperature or humidity in the target space S. The air conditioner 4 may be a fan. The fan adjusts the temperature in the target space S by moving the air within the target space S, and thus corresponds to an aspect of the air conditioner 4. The air conditioner 4 may be a heater that only emits warm air. The air conditioner 4 may be a humidifier or a dehumidifier.

The controller 10 includes one or more central processing units (CPUs) or micro-processing units (MPU). The controller 10 may be configured as circuity including (1) one or more processors that execute various processes according to computer programs (software), (2) one or more dedicated hardware circuits such as application-specific integrated circuits (ASICs) that execute at least some of the processes, or (3) a combination of processors and hardware circuits. The processor includes a CPU and a memory such as a RAM and a ROM. The memory stores program codes or commands configured to cause the CPU to execute processes. The memory, or a computer-readable medium, includes any type of media that are accessible by general-purpose computers and dedicated computers. The memory 11 is separate from the controller 10. The memory 11 includes any type of medium that is accessible by general-purpose computers and dedicated computers. The memory 11 includes a memory such as a RAM and a ROM. The memory 11 may include a hard disk, magnetic tape, optical disk, or magnetic disk. The memory 11 stores relational information that indicates the relationship between a first airflow rate W1 and a second airflow rate W2. Relational information may be stored in a memory of the controller 10.

For example, the controller 10 is mounted on a board. The controller 10 may be mounted on the outside air drawing device 2. The controller 10 may be mounted on the air treatment device 3. The controller 10 may be independent of the outside air drawing device 2 and the air treatment device 3. The controller 10 may be connected to a network. The controller 10 may be managed via the network from an external terminal.

The controller 10 communicates with the outside air drawing device 2. For example, the controller 10 communicates with a control unit 2A of the outside air drawing device 2. The control unit 2A adjusts the airflow rate for the outside air drawing device 2 to a commanded airflow rate by controlling the fan of the outside air drawing device 2 based on commands from the controller 10.

The controller 10 communicates with the air treatment device 3. For example, the controller 10 communicates with a control unit 3A of the air treatment device 3. The control unit 3A adjusts the airflow rate for the air treatment device 3 to a commanded airflow rate by controlling the fan of the air treatment device 3 based on commands from the controller 10.

The controller 10 sets the first airflow rate W1 for the outside air drawing device 2 and the second airflow rate W2 for the air treatment device 3. The controller 10 refers to a required airflow rate WA and one of the first airflow rate W1 and the second airflow rate W2 to set the other one of the first airflow rate W1 and the second airflow rate W2. The required airflow rate WA is necessary to bring the target substance concentration to an objective concentration. The first airflow rate W1 is the flow rate of the air drawn into the target space S by the outside air drawing device 2. The second airflow rate W2 is the flow rate of the air treated by the air treatment device 3.

FIG. 2 illustrates the relationship between the required airflow rate WA, the first airflow rate W1, and the second airflow rate W2. The relationship between the required airflow rate WA, the first airflow rate W1, and the second airflow rate W2, shown in FIG. 2, is an example of the above-mentioned relational information. This figure shows an intermediate airflow rate WX that is the flow rate of the air that does not contain the target substance T that will be expelled from the air treatment device 3. The first airflow rate W1 is assumed to be air that does not contain the target substance T, as it is outside air.

As shown in FIG. 2, the controller 10 adjusts the airflow rates for the outside air drawing device 2 and the air treatment device 3 such that the sum of the first airflow rate W1 and the intermediate airflow rate WX is equal to the required airflow rate WA. The controller 10 then issues commands to each device to operate at a predetermined airflow rate. The required airflow rate WA may be a fixed value set by a user's operation. The required airflow rate WA may be updated as needed. For example, the controller 10 updates the required airflow rate WA based on the number of users entering and exiting the target space S. Users entering and exiting the target space S are detected by, for instance, sensors.

### Required Airflow Rate

The required airflow rate WA may be set by selecting a preset airflow rate level. For example, the airflow rate level is selected by the user operating the controller 10.

The required airflow rate WA may be set for each target substance T. For example, the required airflow rate WA is set to X1 for coronavirus, X2 for influenza, and X3 for PM2.5. In this case, the required airflow rate WA is set by selecting the target substance T. The target substance T is selected by the user operating the controller 10.

The controller 10 may calculate the required airflow rate WA. For example, the controller 10 calculates the required airflow rate WA based on setting information. The setting information refers to either the number of users using the target space S (hereinafter referred to as the number of users) or the assumed number of infected individuals. The setting information may include an infection prevention level. The setting information may include a risk level.

In Example 1, the controller 10 calculates the required airflow rate WA based on the number of users using the target space S (hereinafter referred to as the number of users). Specifically, the controller 10 calculates the required airflow rate WA based on the pathogen removal capacity needed per infected individual and the number of users. For example, the controller 10 calculates the required airflow rate WA by multiplying the pathogen removal capacity needed per infected individual by the number of users.

In Example 2, the controller 10 calculates the required airflow rate WA based on the pathogen removal capacity needed per infected individual and the assumed number of infected individuals. For example, the controller 10 calculates the required airflow rate WA by multiplying the pathogen removal capacity needed per infected individual by the assumed number of infected individuals.

The pathogen removal capacity needed per infected individual is expressed in terms of airflow rate. The pathogen removal capacity required per infected individual may be determined based on World Health Organization (WHO) criteria. For example, the pathogen removal capacity required per infected individual is determined based on the criteria recommended by the WHO for medical facilities. The criteria recommended by the WHO for medical facilities are outlined in the 2009 guideline titled “Natural Ventilation for Infection Control in Health-Care Settings.” The pathogen removal capacity required per infected individual may differ from the criteria recommended by the WHO for medical facilities.

In Example 3, according to the infection prevention level, the controller 10 corrects the required airflow rate WA that has been calculated in the above-described Example 1 or 2. When the infection prevention level is relatively high, the spread of infection is less likely. Thus, when the infection prevention level is relatively high, the controller 10 reduces the required airflow rate WA. Specifically, the controller 10 corrects the required airflow rate WA calculated in Example 1 or 2 such that the required airflow rate WA decreases. For example, the controller 10 has a first coefficient corresponding to the infection prevention level. The higher the infection prevention level, the smaller the first coefficient. The first coefficient is a value between 0 and 1, inclusive. The controller 10 adjusts the required airflow rate WA using the first coefficient. By multiplying the first coefficient by the required airflow rate WA that has been calculated from the above-described Example 1 or 2, the controller 10 derives a new required airflow rate WA.

In Example 4, based on the classification of the risk level, the controller 10 adjusts the required airflow rate WA that has been calculated in the above-described Example 1, 2, or 3. When the risk level is relatively high, the risk of severe illness increases. For this reason, when the risk level is relatively high, the controller 10 increases the required airflow rate WA. Specifically, the controller 10 corrects the required airflow rate WA calculated in Example 1, 2, or 3 such that the required airflow rate WA increases. For example, the controller 10 has a second coefficient corresponding to the risk level. The higher the risk level, the larger the second coefficient. The second coefficient is a value of greater than or equal to 0. The controller 10 corrects the required airflow rate WA using the second coefficient. By multiplying the second coefficient by the required airflow rate WA that has been calculated from the above-described Example 1, 2, or 3, the controller 10 derives a new required airflow rate WA.

### Example 1 of Air Conditioning Coordination System

In Example 1 of the air conditioning coordination system 1, the second airflow rate W2 is derived based on the required airflow rate WA and the first airflow rate W1. In this example, the first airflow rate W1 is preferentially set over the second airflow rate W2. The target space S is an indoor space. The target substance T is a pathogen. The outside air drawing device 2 is a ventilation device. The air treatment device 3 is the air conditioner 4. The air treatment device 3 includes the treatment unit 6A.

The controller 10 receives the required airflow rate WA based on the user's operation. The controller 10 receives the first airflow rate WI based on the user's operation. The controller 10 sets the second airflow rate W2 based on the required airflow rate WA and the first airflow rate W1. For example, the controller 10 calculates the intermediate airflow rate WX by subtracting the first airflow rate W1 from the required airflow rate WA. The controller 10 corrects the intermediate airflow rate WX using a conversion value. The controller 10 sets the value obtained through correction as the second airflow rate W2.

The conversion value indicates the ratio of the airflow rate from which the target substance T has been removed to the flow rate of the air treated by the air treatment device 3. For instance, in a case in which the air treatment device 3 treats air, when the concentration of the target substance T in the air to be expelled changes from 100 at intake to 30, the conversion value is set to 0.7. This is a calculation method that assumes 70% of the target substance T in the intake air has been removed when the concentration changes from 100 at intake to 30. When the conversion value is 0.7, the controller 10 outputs, as the second airflow rate W2, the value obtained by dividing the intermediate airflow rate WX by the conversion value (0.7).

### Example 2 of Air Conditioning Coordination System

In Example 2 of the air conditioning coordination system 1, the first airflow rate W1 is derived based on the required airflow rate WA and the second airflow rate W2. In this example, the second airflow rate W2 is preferentially set over the first airflow rate W1. The target space S is an indoor space. The target substance T is a pathogen. The outside air drawing device 2 is a ventilation device. The air treatment device 3 is the air conditioner 4. The air treatment device 3 includes the treatment unit 6A.

The air treatment device 3 sets the second airflow rate W2 based on an indoor temperature TA and a set temperature. The set temperature is an objective indoor temperature that is set by the user. The user refers to either the person inside the room or the air conditioning manager responsible for managing the indoor environment.

The controller 10 receives the required airflow rate WA based on the user's operation. The controller 10 receives the second airflow rate W2 from the air treatment device 3. The controller 10 sets the first airflow rate W1 based on the required airflow rate WA and the second airflow rate W2. For example, the controller 10 corrects the second airflow rate W2 using the conversion value. The controller 10 sets the value obtained by the correction as the corrected airflow rate. When the conversion value is 0.7, the controller 10 calculates the corrected airflow rate by multiplying the second airflow rate W2 by the conversion value (0.7) and outputs it as the corrected airflow rate. Then, the controller 10 outputs, as the first airflow rate W1, the value obtained by subtracting the corrected airflow rate from the required airflow rate WA.

### Operation

In conventional systems, the outside air drawing device 2 and the air treatment device 3 each have their own specific installation purposes. Thus, they operate independently of each other. The outside air drawing device 2 is installed in buildings for ventilation purposes. The air treatment device 3 is installed in buildings for air conditioning purposes. When the outside air drawing device 2 and the air treatment device 3 are installed in a predetermined space, they target the same space for their operations. That is, the target space S, which is subject to the outside air drawing device 2 and the air treatment device 3, is acted upon by both devices. As a result, the predetermined state quantity of the target space S changes due to the operation of both devices. Consequently, the predetermined state quantity may significantly deviate from the objective. Alternatively, the predetermined state quantity may be maintained in equilibrium due to the excessive operation of both devices. In this manner, either or both devices may be operating unnecessarily. The controller 10 of the air conditioning coordination system 1 adjusts the airflow rates for both devices. This allows for energy savings in air conditioning. Additionally, the controller 10 sets the airflow rate for one of the two devices as a priority before setting the airflow rate for the other. This reduces the complexity in coordination control.

### Advantages

The advantages of the present embodiment will now be described.

(1) The air conditioning coordination system 1 includes the outside air drawing device 2, the air treatment device 3, and the controller 10. The controller 10 sets the first airflow rate W1 for the outside air drawing device 2 and the second airflow rate W2 for the air treatment device 3. The controller 10 refers to the required airflow rate WA and one of the first airflow rate W1 and the second airflow rate W2 to set the other one of the first airflow rate W1 and the second airflow rate W2. The first airflow rate W1 is the flow rate of air that is drawn into the target space S by the outside air drawing device 2. The second airflow rate W2 is the flow rate of air treated by the air treatment device 3. In this configuration, when bringing the target substance concentration closer to the objective concentration, more energy is saved compared to when the outside air drawing device 2 and the air treatment device 3 operate independently.

(2) The target substance concentration is the pathogen concentration, pollen concentration, PM concentration, dust concentration, or hazardous chemical concentration in the target space S. In this configuration, when bringing the pathogen concentration, pollen concentration, PM concentration, dust concentration, or hazardous chemical concentration in the target space S closer to the objective concentration, energy savings are achieved.

### Second Embodiment

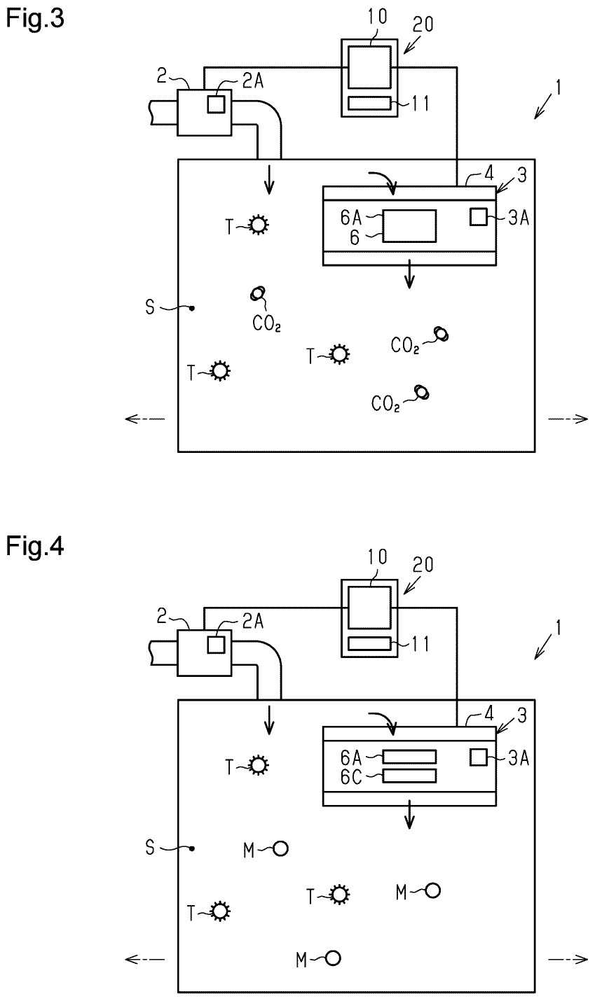

The air conditioning coordination system 1 according to a second embodiment will now be described with reference to FIG. 3. In the air conditioning coordination system 1 of the present embodiment, same reference characters are given to those elements that are the same as the corresponding elements of the first embodiment. Such elements will not be described in detail.

The air conditioning coordination system 1 according to the present embodiment is the same as Example 1 of the first embodiment, except for the following points. In Example 1, the first airflow rate W1 is set through the user's operation. In the present embodiment, the first airflow rate W1 is set based on a predetermined rule.

The air conditioning coordination system 1 adjusts the target substance concentration in the target space S through the coordination between the outside air drawing device 2 and the air treatment device 3. The target substance T is, for example, a pathogen. The air conditioning coordination system 1 further adjusts a first selected state quantity of the target space S. The first selected state quantity is a state quantity of the target space S that differs from the target substance concentration and is changed by at least one of the outside air drawing device 2 and the air treatment device 3.

The first selected state quantity is different from the target substance concentration and is adjusted by drawing outside air using the outside air drawing device 2. The first selected state quantity is difficult to adjust using the air treatment device 3. For example, the first selected state quantity is a carbon dioxide concentration in the target space S. Although carbon dioxide (CO₂) can be removed through a predetermined chemical process, the equipment required for this process tends to be relatively large. Thus, carbon dioxide (CO₂) is selected as the first selected state quantity as the amount that can be adjusted solely by the outside air drawing device 2.

The controller 10 sets the first airflow rate W1 such that the first selected state quantity of the target space S satisfies a first criterion.

The controller 10 has an airflow rate range that is set such that the first selected state quantity satisfies the first criterion. The first criterion is set in advance. For example, the first criterion indicates the first selected state quantity at which people can comfortably spend time in the target space S. In the present embodiment, the first criterion is set as the range of the carbon dioxide concentration at which people can comfortably spend time in the target space S. The following are two examples of the control executed by the controller 10.

### Example 1

The controller 10 determines whether the first selected state quantity of the target space S satisfies the first criterion using a sensor that detects the first selected state quantity. For example, when the first selected state quantity is the carbon dioxide concentration, the controller 10 determines whether the first selected state quantity of the target space S is less than or equal to a first reference value based on a concentration detection value from a carbon dioxide sensor disposed in the target space S. When the concentration detection value from the carbon dioxide sensor is greater than the first reference value, the controller 10 sets the first airflow rate W1 such that the concentration detection value from the carbon dioxide sensor approaches the first reference value. For example, the controller 10 sets the first airflow rate W1 based on the difference between the concentration detection value from the carbon dioxide sensor and the first reference value. Through such control, when the concentration detection value of the carbon dioxide sensor becomes greater than the first reference value and the difference becomes larger, the first air volume W1 increases. As the concentration detection value from the carbon dioxide sensor approaches the first reference value, the first airflow rate W1 gradually decreases and then converges to a constant airflow rate. Additionally, the controller 10 sets the second airflow rate W2 based on the first airflow rate W1 each time the first airflow rate W1 is set. Specifically, the controller 10 sets the second airflow rate W2 based on the required airflow rate WA and the first airflow rate W1 in the same manner as Example 1 of the first embodiment.

### Example 2

The first criterion may have different levels that are selected by the user. The level of the first criterion is selected by the user. For each level of the first criterion, the airflow rate range is set corresponding to that level. When the level of the first criterion is relatively low (i.e., the concentration is relatively low), the first airflow rate W1 is set to a relatively large value as there is need to reduce the concentration. When the level of the first criterion is relatively high (i.e., the concentration is relatively high), the first airflow rate W1 is set to a relatively small value as there is little need to reduce the concentration. For example, when the first selected state quantity is the carbon dioxide concentration, it is set as follows. When the carbon dioxide concentration is at a first level (A1 ppm or more and less than A2 ppm), the airflow rate range is set to be greater than or equal to B2 and less than B3. When the carbon dioxide concentration is at a second level (A2 ppm or more and less than A3 ppm), the airflow rate range is set to be greater than or equal to B1 and less than B2. In such cases, the controller 10 sets the minimum amount within the airflow rate range corresponding to the level selected by the user to the first airflow rate W1. Setting the minimum amount in this manner limits the drawing of outside air while still satisfying the level of the first criterion set by the user.

For example, when the level of the first criterion is set to the first level by the user, the controller 10 sets the first airflow rate WI to a minimum amount B2 within the airflow rate range of B2 or more and less than B3. Then, the controller 10 sets the second airflow rate W2 based on the first airflow rate W1. Specifically, the controller 10 sets the second airflow rate W2 based on the required airflow rate WA and the first airflow rate W1 in the same manner as Example 1 of the first embodiment.

### Example 3

In Example 1, the controller 10 sets the first airflow rate W1 such that the first selected state quantity of the target space S satisfies the first criterion. The controller 10 sets the second airflow rate W2 based on the first airflow rate W1 each time the first airflow rate W1 is set.

In Example 3, the controller 10 sets the first airflow rate W1 and the second airflow rate W2 based on the following relational information. The relational information is stored in the memory 11 in advance. The relational information indicates the relationship between the first airflow rate W1, the second airflow rate W2, and the first selected state quantity, which is a state quantity of the target space S that differs from the target substance concentration and is changed by at least one of the outside air drawing device 2 and the air treatment device 3.

### Example 3-1

The relational information includes first derivation information used to derive the first airflow rate W1 based on the first selected state quantity, and second derivation information used to derive the second airflow rate W2 based on the first airflow rate W1. For example, the first derivation information associates the first selected state quantity with the first airflow rate W1 such that the value of the first airflow rate W1 increases as the value of the first selected state quantity increases. The second derivation information is configured to satisfy the relationship between the first airflow rate W1 and the second airflow rate W2 as indicated in the first embodiment. The relationship indicated in the first embodiment is that the sum of the first airflow rate W1 and the intermediate airflow rate WX is equal to the required airflow rate WA. This ensures that the target space S is adequately ventilated.

The controller 10 may have an airflow rate range that is set such that the first selected state quantity satisfies the first criterion. The airflow rate range is set in advance. The airflow rate range is stored in the memory 11. The controller 10 sets the first airflow rate W1 to the minimum amount of the airflow rate range set for the first selected state quantity of the target space S. For example, the minimum amount is set as the minimum value required for optimal ventilation. The minimum amount may be set to any value. The minimum amount may be changed based on the number of people in the target space S. In this configuration, the first selected state quantity satisfies the first criterion in the target space S.

### Example 3-2

For example, the relational information is configured such that the first selected state quantity of the target space S satisfies the first criterion. In the relational information, the relationship between the first selected state quantity, the first airflow rate W1, and the second airflow rate W2 is set to ensure that the first selected state quantity of the target space S satisfies the first criterion. For instance, when the value of the first selected state quantity is greater than the first reference value and the difference between the first selected state quantity and the first reference value becomes larger, the relational information is set such that the first airflow rate W1 is larger than the second airflow rate W2 and the difference between them increases. Further, the value of the first airflow rate W1 and the value of the second airflow rate W2 are set for each value of the first selected state quantity. That is, the first selected state quantity, the first airflow rate W1, and the second airflow rate W2 are organized in a table data format. In this case, the controller 10 refers to the relational information to set the first airflow rate W1 and the second airflow rate W2 based on the selected state quantity.

### Example 3-3

Another example of the relational information includes first setting information and second setting information. The first information is used to set the first airflow rate W1 such that the first selected state quantity of the target space S satisfies the first criterion. The first setting information is configured according to the size of the target space S. The larger the target space S, the larger first airflow rate W1. Additionally, the first setting information may be configured based on the ease of natural ventilation and the size of the target space S. The second setting information indicates the relationship between the first airflow rate W1 and the second airflow rate W2. Using the second setting information, the second airflow rate W2 can be set based on the first airflow rate W1. In this case, the controller 10 sets the first airflow rate W1 such that the first selected state quantity of the target space S satisfies the first criterion. Then, the controller 10 sets the second airflow rate W2 based on the first airflow rate W1.

### Advantages

The advantages of the present embodiment will now be described.

(1) The controller 10 sets the first airflow rate W1 and the second airflow rate W2 from the relational information based on the first selected state quantity. In this configuration, when the target substance concentration (target state quantity) in the target space S is adjusted, the first airflow rate W1 and the second airflow rate W2 are set in a predetermined relationship. Thus, more energy is saved compared to when the outside air drawing device 2 and the air treatment device 3 operate independently.

(2) The relational information includes the first derivation information, which is used to derive the first airflow rate W1 based on the first selected state quantity, and the second derivation information, which is used to derive the second airflow rate W2 based on the first airflow rate W1. This configuration allows the first airflow rate W1 to be set based on the first selected state quantity. This configuration also allows the second airflow rate W2 to be set based on the first airflow rate W1.

(3) The controller 10 sets the first airflow rate WI to the minimum amount of the airflow rate range set for the first selected state quantity of the target space S. In this configuration, the first airflow rate WI is set to the minimum amount. Thus, when adjusting the air state of the target space S such that the concentration of the target substance (target state quantity) is adjusted and the first selected state quantity satisfies the first criterion, the configuration allows for energy savings while limiting the changes in the indoor environment that may occur when outside air is drawn in.

(4) The first selected state quantity is the carbon dioxide concentration in the target space S. The first selected state quantity may be the temperature or humidity in the target space S. When adjusting the carbon dioxide concentration, temperature, or humidity by the outside air drawing device 2, this configuration achieves energy savings while performing air conditioning for the target space S to adjust the target state quantity and satisfy the criterion of the carbon dioxide concentration, temperature, or humidity.

(5) The air treatment device 3 may include the air purifier 5 with a treatment unit 6B (see details below), and the air conditioner 4 with the treatment unit 6A and an air conditioning unit 7 (see details below) that adjusts the temperature in the target space S. In this case, the second airflow rate W2 includes the airflow rate for the air purifier 5 and the airflow rate for the air conditioner 4. When the air purifier 5 and the air conditioner 4 are operating, this configuration allows for adjustment of the total airflow rate for both devices.

(6) The controller 10 sets the first airflow rate W1 such that the first selected state quantity of the target space S satisfies the first criterion. The controller 10 sets the second airflow rate W2 based on the first airflow rate W1. In this configuration, when adjusting the air state of the target space S such that the target substance concentration approaches the objective concentration and the first selected state quantity satisfies the first criterion, energy savings are achieved.

(7) The controller 10 sets the first airflow rate W1 to the minimum amount of the airflow rate range set for the first selected state quantity of the target space S. In this configuration, the first airflow rate W1 is set to the minimum amount. This reduces the amount of outside air drawn into the target space S. Thus, when adjusting the air state of the target space S such that the target substance concentration approaches the objective concentration and the first selected state quantity satisfies the first criterion, the configuration allows for energy savings while limiting the changes in the indoor environment that may occur when outside air is drawn in.

(8) The first selected state quantity is, for example, the carbon dioxide concentration in the target space S. When adjusting the carbon dioxide concentration by the outside air drawing device 2, this configuration allows for energy savings while performing air conditioning for the target space S such that the target substance concentration approaches the objective concentration and the carbon dioxide concentration satisfies its criterion.

### Third Embodiment

The air conditioning coordination system 1 according to a third embodiment will now be described with reference to FIG. 4. In the air conditioning coordination system 1 of the present embodiment, same reference characters are given to those elements that are the same as the corresponding elements of the first embodiment. Such elements will not be described in detail.

The air conditioning coordination system 1 according to the present embodiment is the same as Example 2 of the first embodiment, except for the following points. In Example 2, the second airflow rate W2 is set by the air treatment device 3. In the present embodiment, the second airflow rate W2 is set based on another rule.

The air conditioning coordination system 1 adjusts the target substance concentration in the target space S through the coordination between the outside air drawing device 2 and the air treatment device 3. The target substance T is, for example, a pathogen. The air conditioning coordination system 1 further adjusts a second selected state quantity of the target space S.

The second selected state quantity is different from the target substance concentration and is removed through the air treatment performed by the air treatment device 3. The second selected state quantity is an amount that is difficult to adjust using the outside air drawing device 2. For example, the second selected state quantity is the PM concentration of the target space S. When the building including the target space S is located along a highway, the outdoor PM concentration may be higher than the indoor PM concentration. In such a case, the PM concentration is difficult to adjust using the outside air drawing device 2. Thus, PM is selected as the second selected state quantity that can be adjusted only by the air treatment device 3. In this case, the air treatment device 3 includes a PM removal filter.

The air treatment device 3 is the air conditioner 4 with a purification function. The air treatment device 3 includes the treatment unit 6A capable of treating the target substance T, as well as an additional treatment unit 6C capable of treating a substance M related to the second selected state quantity. In the present embodiment, the substance M related to the second selected state quantity is PM. The additional treatment unit 6C removes PM from the air. For example, the additional treatment unit 6C includes a PM removal filter.

The controller 10 sets the second airflow rate W2 such that the second selected state quantity of the target space S satisfies a second criterion. The second criterion is set in advance. For example, the second criterion indicates the second selected state quantity at which people can comfortably spend time in the target space S. In the present embodiment, the second standard is set as the range of the PM concentration in which people can comfortably spend in the target space S. The following is an example of the control executed by the controller 10.

The controller 10 determines whether the second selected state quantity of the target space S satisfies the second criterion based on a sensor that detects the second selected state quantity. For example, when the second selected state quantity is the PM concentration, the controller 10 determines whether the second selected state quantity of the target space S is less than or equal to a second reference value based on a concentration detection value from a PM concentration sensor disposed in the target space S. When the concentration detection value from the PM concentration sensor is greater than the second reference value, the controller 10 sets the second airflow rate W2 such that the concentration detection value from the PM concertation sensor approaches the second reference value. For example, the controller 10 sets the second airflow rate W2 based on the difference between the concentration detection value from the PM concentration sensor and the second reference value. Through such control, when the concentration detection value of the PM concentration sensor becomes greater than the second reference value and the difference becomes larger, the second air volume W2 increases. As the concentration detection value from the PM concentration sensor approaches the second reference value, the second airflow rate W2 gradually decreases and then converges to a constant airflow rate. Additionally, the controller 10 sets the first airflow rate WI based on the second airflow rate W2 each time the second airflow rate W2 is set. Specifically, the controller 10 sets the first airflow rate W1 based on the required airflow rate WA and the second airflow rate W2 in the same manner as Example 2 of the first embodiment.

### Another Example

In the above example of the present embodiment, the controller 10 sets the second airflow rate W2 such that the second selected state quantity of the target space S satisfies the second criterion. The controller 10 sets the first airflow rate W1 based on the second airflow rate W2 each time the second airflow rate W2 is set.

In this example, the controller 10 may set the first airflow rate W1 and the second airflow rate W2 based on the following relational information. The relational information is stored in the memory 11 in advance. The relational information includes third derivation information used to derive the second airflow rate W2 based on the second selected state quantity and fourth derivation information used to derive the first airflow rate W1 based on the second airflow rate W2. For example, the third derivation information correlates the second selected state quantity with the second airflow rate W2 such that the value of the second airflow rate W2 increases as the value of the second selected state quantity increases. The fourth derivation information is configured to satisfy the relationship between the first airflow rate W1 and the second airflow rate W2 as indicated in the first embodiment. The relationship indicated in the first embodiment is that the sum of the first airflow rate W1 and the intermediate airflow rate WX is equal to the required airflow rate WA. This ensures that the target space S is adequately ventilated.

### Advantages

The advantages of the present embodiment will now be described.

(1) The relational information includes the third derivation information, which is used to derive the second airflow rate W2 based on the second selected state quantity, and the fourth derivation information, which is used to derive the first airflow rate W1 based on the second airflow rate W2. In this configuration, when adjusting the air state of the target space S such that the target substance concentration (target state quantity) is adjusted and the second selected state quantity satisfies the second criterion, energy savings are achieved.

(2) The controller 10 sets the second airflow rate W2 such that the second selected state quantity of the target space S satisfies the second criterion, and sets the first airflow rate W1 based on the second airflow rate W2. In this configuration, when adjusting the air state of the target space S such that the target substance concentration approaches the objective concentration and the second selected state quantity satisfies the second criterion, energy savings are achieved.

### Fourth Embodiment

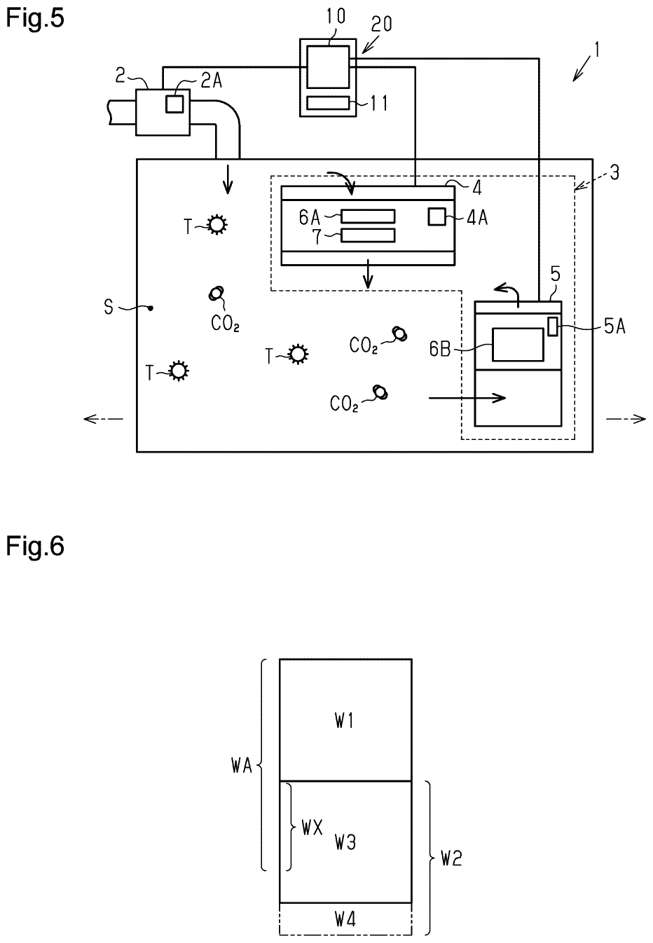

The air conditioning coordination system 1 according to a fourth embodiment will now be described with reference to FIG. 5. In the air conditioning coordination system 1 of the present embodiment, same reference characters are given to those elements that are the same as the corresponding elements of the second embodiment. Such elements will not be described in detail.

The air conditioning coordination system 1 according to the present embodiment includes the second embodiment. The air conditioning coordination system 1 of the present embodiment differs from the second embodiment in the following aspects. In the second embodiment, the air treatment device 3 is the air conditioner 4 with a purification function. In the present embodiment, the air treatment device 3 includes multiple devices.

For example, the air treatment device 3 includes the air purifier 5 and the air conditioner 4.

The air purifier 5 includes the treatment unit 6B.

The air conditioner 4 includes the air conditioning unit 7, which adjusts the temperature in the target space S, and the treatment unit 6A.

In such an air conditioning coordination system 1, the target substance T is adjusted by the outside air drawing device 2, the air purifier 5, and the air conditioner 4.

The first airflow rate W1 includes the airflow rate for the outside air drawing device 2.

The second airflow rate W2 includes the airflow rate for the air purifier 5 and the airflow rate for the air conditioner 4.

The third airflow rate W3 is defined as the airflow rate treated by the treatment unit 6B in the air purifier 5.

The fourth airflow rate W4 is defined as the airflow rate treated by the air conditioning unit 7 and the treatment unit 6A in the air conditioner 4. This airflow rate is set based on the temperature in the target space S.

The air conditioning coordination system 1 adjusts the target substance concentration in the target space S through the coordination of the outside air drawing device 2, the air purifier 5, which is a device included in the air treatment device 3, and the air conditioner 4, which is another device included in air treatment device 3.

The controller 10 communicates with the control unit 2A of the outside air drawing device 2. The control unit 2A adjusts the airflow rate for the outside air drawing device 2 to a commanded airflow rate by controlling the fan of the outside air drawing device 2 based on commands from the controller 10.

The controller 10 communicates with the control unit 4A of the air conditioner 4. The control unit 4A adjusts the airflow rate for the air conditioner 4 to a commanded airflow rate by controlling the fan of the air conditioner 4 based on commands from the controller 10.

The controller 10 communicates with the control unit 5A of the air purifier 5. The control unit 5A adjusts the airflow rate for the air purifier 5 to a commanded airflow rate by controlling the fan of the air purifier 5 based on commands from the controller 10.

The target substance T is, for example, a pathogen. The air conditioning coordination system 1 further adjusts the first selected state quantity of the target space S. The first selected state quantity is the carbon dioxide concentration in the target space S.

The controller 10 sets the first airflow rate W1 such that the first selected state quantity (for example, the carbon dioxide concentration) of the target space S satisfies the first criterion.

The controller 10 sets the second airflow rate W2 based on the first airflow rate W1. Specifically, the controller 10 sets the second airflow rate W2 based on the required airflow rate WA and the first airflow rate W1 in the same manner as Example 1 of the first embodiment. For example, the controller 10 derives the intermediate airflow rate WX as the value obtained by subtracting the first airflow rate W1 from the required airflow rate WA. The controller 10 derives the second airflow rate W2 based on the intermediate airflow rate WX and the conversion value. In the present embodiment, the conversion value of the air conditioner 4 is equal to the conversion value of the air purifier 5. The second airflow rate W2 is a flow rate of air that should be treated by the air conditioner 4 and the air purifier 5.

The air conditioner 4 sets the fourth airflow rate W4 based on the indoor temperature TA and a set temperature. The set temperature is the objective indoor temperature set by the user. The user refers to either the person inside the room or the air conditioning manager responsible for managing the indoor environment.

The controller 10 sets the third airflow rate W3 based on the second airflow rate W2 and the fourth airflow rate W4. Specifically, the controller 10 acquires the fourth airflow rate W4 from the air conditioner 4. The controller 10 outputs, as the third airflow rate W3, the value obtained by subtracting the fourth airflow rate W4 from the second airflow rate W2.

FIG. 6 illustrates the relationship between the required airflow rate WA, the first airflow rate W1, the second airflow rate W2, the third airflow rate W3, and the fourth airflow rate W4. In this manner, the controller 10 adjusts the airflow rates for the outside air drawing device 2, the air conditioner 4, and the air purifier 5 such that the sum of the first airflow rate W1, the third airflow rate W3, and the fourth airflow rate W4 is equal to the required airflow rate WA. The controller 10 then issues commands to each device to operate at a predetermined airflow rate.

### Advantages

The advantages of the present embodiment will now be described.

(1) In the present embodiment, the air treatment device 3 includes the air purifier 5 with the treatment unit 6B, and the air conditioner 4 with the treatment unit 6A and the air conditioning unit 7, which adjusts the temperature in the target space S. The first selected state quantity is the carbon dioxide concentration in the target space S. The second airflow rate W2 includes the airflow rate for the air purifier 5 and the airflow rate for the air conditioner 4. The controller 10 sets the first airflow rate W1 such that the first selected state quantity of the target space S satisfies the first criterion. Then, the controller 10 sets the second airflow rate W2 based on the first airflow rate W1.

When adjusting the carbon dioxide concentration by the outside air drawing device 2, this configuration allows for energy savings while performing air conditioning for the target space S such that the target substance concentration approaches the objective concentration and the carbon dioxide concentration satisfies its criterion.

(2) The controller 10 sets the third airflow rate W3 based on the second airflow rate W2 and the fourth airflow rate W4. The third airflow rate W3 is treated by the treatment unit 6B in the air purifier 5. The fourth airflow rate W4 is treated by the air conditioning unit 7 and the treatment unit 6A in the air conditioner 4. This airflow rate is set based on the temperature in the target space S.

In this configuration, with regard to airflow rate, the operation of the air purifier 5 is coordinated with the operation of the air conditioner 4. Thus, more energy is saved compared to when such coordination is not performed.

### Fifth Embodiment

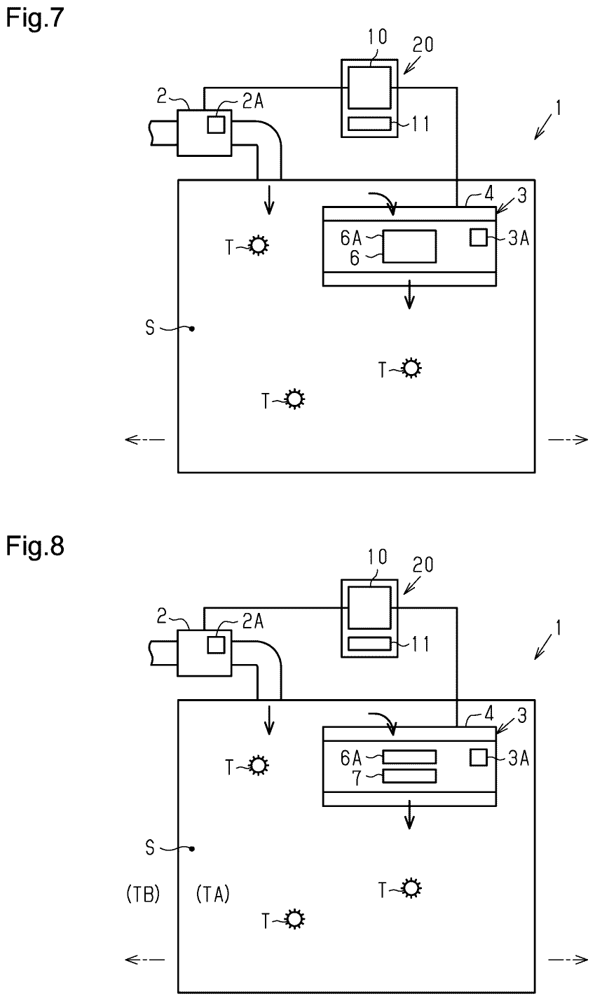

The air conditioning coordination system 1 according to a fifth embodiment will now be described with reference to FIG. 7. In the air conditioning coordination system 1 of the present embodiment, same reference characters are given to those elements that are the same as the corresponding elements of the first embodiment. Such elements will not be described in detail.

The air conditioning coordination system 1 according to the present embodiment is the same as Example 1 of the first embodiment, except for the following points. In Example 1, the first airflow rate W1 is set through the user's operation. In the present embodiment, the first airflow rate W1 is set based on a predetermined rule.

The air conditioning coordination system 1 adjusts the target substance concentration in the target space S through the coordination between the outside air drawing device 2 and the air treatment device 3. The air treatment device 3 includes the air purifier 5. The air treatment device 3 does not include the air conditioner 4. Alternatively, the air treatment device 3 includes the air conditioner 4 that is not running. The target substance T is, for example, a pathogen. The air conditioning coordination system 1 further adjusts the first selected state quantity of the target space S.

The first selected state quantity is different from the target substance concentration and is adjusted by drawing outside air using the outside air drawing device 2. The first selected state quantity is difficult to adjust using the air treatment device 3. In the present embodiment, the first selected state quantity is the temperature or humidity in the target space S. In the present embodiment, the air treatment device 3 does not include the air conditioner 4. Alternatively, the air treatment device 3 is not running. Thus, the temperature or humidity in the target space S is difficult to adjust using the air treatment device 3. Thus, the temperature or humidity is selected as the first selected state quantity as the amount that can be adjusted solely by the outside air drawing device 2.

Examples of the target space S in which the air conditioner 4 is not installed include an open dome space. In a dome space where exhibitions are held, infection control measures are necessary because of the crowd of people. Thus, the concentration of the target substance (e.g., pathogens) in the target space S is managed. The temperature or humidity in the target space S is adjusted by drawing outside air in.

The controller 10 sets the first airflow rate W1 such that the first selected state quantity of the target space S satisfies the first criterion.

The controller 10 has an airflow rate range that is set such that the first selected state quantity satisfies the first criterion. The first criterion is set in advance. For example, the first criterion indicates the first selected state quantity at which people can comfortably spend time in the target space S. In the present embodiment, the first criterion is set as the range of temperature or humidity in which people can comfortably spend time in the target space S. The following is an example of the control executed by the controller 10.

The controller 10 determines whether the first selected state quantity of the target space S satisfies the first criterion using a sensor that detects the first selected state quantity. For example, when the first selected state quantity is temperature, the controller 10 determines whether the first selected state quantity of the target space S is within the reference range of the first criterion based on a temperature detection value from a temperature sensor disposed in the target space S. When the temperature detection value from the temperature sensor is not within the reference range of the first criterion, the controller 10 sets the first airflow rate W1 such that the temperature detection value from the temperature sensor approaches the first reference value. The reference range is set around the first reference value. This range is considered as satisfying the first criterion and set in advance. The following are two examples of the present embodiment.

### Example 1

In Example 1, the outside air drawing device 2 includes a temperature regulator that adjusts the temperature of outside air. The temperature of outside air is adjusted by the temperature regulator included in the outside air drawing device 2. The temperature regulator includes a heat exchanger for a refrigerant circuit.

When the temperature in the target space S is higher than the upper limit of the reference range of the first reference value, the controller 10 controls the refrigerant circuit and sets the first airflow rate W1 such that the outside air temperature becomes lower than the first reference value to bring the temperature in the target space S closer to the first reference value. The controller 10 sets the first airflow rate W1 based on the difference between the temperature in the target space S and the first reference value. Through such control, when the temperature in the target space S becomes greater than the first reference value and the difference becomes larger, the first air volume WI increases. As the temperature in the target space S approaches the first reference value, the first airflow rate W1 gradually decreases and then converges to a constant airflow rate.

When the temperature in the target space S is lower than the lower limit of the reference range of the first reference value, the controller 10 controls the refrigerant circuit and sets the first airflow rate W1 such that the outside air temperature becomes higher than the first reference value to bring the temperature in the target space S closer to the first reference value. The controller 10 sets the first airflow rate W1 based on the difference between the temperature in the target space S and the first reference value. Through such control, when the temperature in the target space S becomes lower than the first reference value and the difference becomes larger, the first air volume W1 increases. As the temperature in the target space S approaches the first reference value, the first airflow rate W1 gradually decreases and then converges to a constant airflow rate.

The controller 10 sets the second airflow rate W2 based on the first airflow rate W1 each time the first airflow rate W1 is set. Specifically, the controller 10 sets the second airflow rate W2 based on the required airflow rate WA and the first airflow rate W1 in the same manner as Example 1 of the first embodiment.

Control performed when the first selected state quantity is humidity is the same as that performed when the first selected state quantity is temperature.

### Example 2

In Example 2, the outside air drawing device 2 does not function to adjust the temperature of outside air, and directly draws it in. The controller 10 sets the first airflow rate W1 based on the difference between the temperature detection value from the temperature sensor and the first reference value. Further, only when the drawing of outside air allows the temperature in the target space S to satisfy the first criterion (hereinafter referred to as “when the condition for drawing outside air in is satisfied”), the controller 10 performs feedback control on the first airflow rate W1 such that the temperature in the target space S satisfies the first criterion. When the drawing of outside air does not allow the temperature in the target space S to satisfy the first criterion, the controller 10 sets the first airflow rate W1 to the minimum amount. The controller 10 determines whether the condition for drawing outside air in is satisfied based on whether the first reference value exists between the temperature of outside air and the temperature in the target space S. The controller 10 determines that the condition for drawing outside air in is satisfied when the first reference value exists between the temperature of outside air and the temperature in the target space S.

With the feedback control performed on the controller 10 when the condition for drawing outside air in is satisfied, the greater the difference between the temperature detection value from the temperature sensor and the first reference value, the larger the first airflow rate W1. As the temperature detection value from the temperature sensor approaches the first reference value, the first airflow rate W1 gradually decreases and then converges to a constant airflow rate. Additionally, the controller 10 sets the second airflow rate W2 based on the first airflow rate W1 each time the first airflow rate W1 is set. Specifically, the controller 10 sets the second airflow rate W2 based on the required airflow rate WA and the first airflow rate W1 in the same manner as Example 1 of the first embodiment.

Control performed when the first selected state quantity is humidity is the same as that performed when the first selected state quantity is temperature.

### Advantages

The advantages of the present embodiment will now be described.

The controller 10 sets the first airflow rate W1 such that the first selected state quantity of the target space S satisfies the first criterion. Then, the controller 10 sets the second airflow rate W2 based on the first airflow rate W1. The first selected state quantity is the temperature in the target space S. The first selected state quantity may be the humidity in the target space S.

In this configuration, when the temperature or humidity in the target space S is adjusted by the outside air drawing device 2, the following advantage is obtained. This configuration allows for energy savings while performing air conditioning for the target space S such that the target substance concentration approaches the objective concentration and the drawing of outside air allows the temperature or humidity in the target space S to satisfy its criterion.

### Sixth Embodiment

The air conditioning coordination system 1 according to a sixth embodiment will now be described with reference to FIG. 8. In the air conditioning coordination system 1 of the present embodiment, same reference characters are given to those elements that are the same as the corresponding elements of the first embodiment. Such elements will not be described in detail.

The air conditioning coordination system 1 according to the present embodiment is the same as Example 1 or 2 of the first embodiment, except for the following points. In Example 1 or 2, the first airflow rate W1 or the second airflow rate W2 is set based on the user's operation. In the present embodiment, the first airflow rate W1 or the second airflow rate W2 is set based on a predetermined rule.

The air conditioning coordination system 1 adjusts the target substance concentration in the target space S through the coordination between the outside air drawing device 2 and the air treatment device 3. The target substance T is, for example, a pathogen. The air treatment device 3 includes the treatment unit 6A and the air conditioning unit 7, which adjusts the temperature in the target space S.

Based on the determination result of whether a first energy consumption is greater than a second energy consumption, the controller 10 prioritizes setting either the first airflow rate W1 or the second airflow rate W2 first.

The first energy consumption is defined as the sum of the following energy consumption (1) and energy consumption (2) when drawing a unit amount of outside air into the target space S. (1) refers to the energy consumption of the outside air drawing device 2 required for drawing outside air in. (2) refers to the energy consumption of the air treatment device 3 required to return the temperature in the target space S, into which a unit amount of outside air has been drawn, back to the temperature it has before the outside air was drawn in.

When a unit amount of air in the target space S is treated, the second energy consumption is defined as the energy consumption of the air treatment device 3 required to treat the unit amount of air

By determining whether the first energy consumption is greater than the second energy consumption, it can be determined whether drawing outside air in is advantageous in terms of the energy consumption of the air conditioning coordination system 1. Thus, the control based on the determination result reduces energy consumption.

The controller 10 determines whether the first energy consumption is greater than the second energy consumption.

Examples of methods for determining whether the first energy consumption is greater than the second energy consumption will be described. For example, the controller 10 can determine whether the first energy consumption is greater than the second energy consumption based on the temperature difference between the indoor temperature TA and an outdoor temperature TB.

When the first energy consumption is greater than the second energy consumption, the controller 10 sets the first airflow rate W1 such that the first energy consumption is less than or equal to its value at the time of determination. Specifically, the controller 10 sets the first airflow rate W1 such that it is less than or equal to the first airflow rate W1 at the time of determination. In one example, the controller 10 sets the first airflow rate W1 to the value obtained by subtracting a predetermined airflow rate from the first airflow rate W1 at the time of determination. In another example, the controller 10 sets the first airflow rate W1 to the value obtained by multiplying the first airflow rate W1 at the time of determination by a coefficient that is less than 1.

The controller 10 sets the second airflow rate W2 based on the first airflow rate W1. Specifically, the controller 10 sets the second airflow rate W2 based on the required airflow rate WA and the first airflow rate W1 in the same manner as Example 1 of the first embodiment.

When the first energy consumption is less than or equal to the second energy consumption, the controller 10 sets the second airflow rate W2 such that the second energy consumption is less than or equal to its value at the time of determination. Specifically, the controller 10 sets the second airflow rate W2 such that it is less than or equal to the second airflow rate W2 at the time of determination. In one example, the controller 10 sets the second airflow rate W2 to the value obtained by subtracting a predetermined airflow rate from the second airflow rate W2 at the time of determination. In another example, the controller 10 sets the second airflow rate W2 to the value obtained by multiplying the second airflow rate W2 at the time of determination by a coefficient that is less than 1.

The controller 10 sets the first airflow rate W1 based on the second airflow rate W2. Specifically, the controller 10 sets the first airflow rate W1 based on the required airflow rate WA and the second airflow rate W2 in the same manner as Example 2 of the first embodiment.

### Advantages

The advantages of the present embodiment will now be described.

The controller 10 determines whether the first energy consumption is greater than the second energy consumption. When the first energy consumption is greater than the second energy consumption, the controller 10 sets the first airflow rate W1 such that the first energy consumption is less than or equal to its value at the time of determination, and sets the second airflow rate W2 based on the first airflow rate W1. When the first energy consumption is less than or equal to the second energy consumption, the controller 10 sets the second airflow rate W2 such that the second energy consumption is less than or equal to its value at the time of determination, and sets the first airflow rate W1 based on the second airflow rate W2.

In this configuration, when the air treatment device 3 performs air conditioning for the target space S, the airflow rate is set such that the energy consumption of the device with a higher energy consumption, when comparing the first and second energy consumptions, is made smaller compared to its level at the time of determination. This reduces the total energy consumption, which is the sum of the energy consumption of the outside air drawing device 2 and the energy consumption of the air treatment device 3.

### Seventh Embodiment

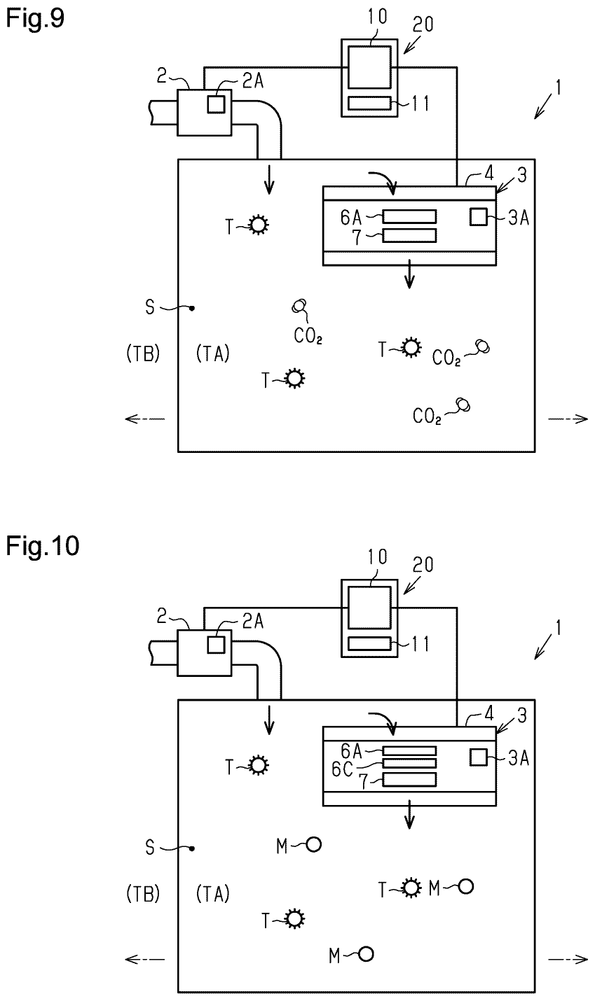

The air conditioning coordination system 1 according to a seventh embodiment will now be described with reference to FIG. 9. In the air conditioning coordination system 1 of the present embodiment, same reference characters are given to those elements that are the same as the corresponding elements of the sixth embodiment. Such elements will not be described in detail.

The air conditioning coordination system 1 of the present embodiment differs from the sixth embodiment in the following aspects. In the sixth embodiment, the first airflow rate W1 or the second airflow rate W2 is set based on the energy consumption. In the present embodiment, the first airflow rate W1 or the second airflow rate W2 is set based on the energy consumption and the first selected state quantity.

The air conditioning coordination system 1 adjusts the target substance concentration in the target space S through the coordination between the outside air drawing device 2 and the air treatment device 3. The target substance T is, for example, a pathogen. The first selected state quantity is the carbon dioxide concentration. The air treatment device 3 includes the treatment unit 6A and the air conditioning unit 7, which adjusts the temperature in the target space S.

Based on the determination result of whether the first energy consumption is greater than the second energy consumption, the controller 10 prioritizes setting either the first airflow rate W1 or the second airflow rate W2 first.

The controller 10 determines whether the first energy consumption is greater than the second energy consumption.

The controller 10 has a predetermined airflow rate for the outside air drawing device 2. This airflow rate is required to ensure that the first selected state quantity satisfies the first criterion in the target space S.

When the first energy consumption is greater than the second energy consumption, the controller 10 sets the first airflow rate W1 to be greater than or equal to the predetermined airflow rate such that the first selected state quantity of the target space S satisfies the first criterion.

When the first energy consumption is greater than the second energy consumption, the controller 10 sets the first airflow rate WI such that the first energy consumption is less than or equal to its value at the time of determination. Specifically, the controller 10 sets the first airflow rate W1 such that it is less than or equal to the first airflow rate W1 at the time of determination. In one example, the controller 10 sets the first airflow rate W1 to the value obtained by subtracting the predetermined airflow rate from the first airflow rate W1 at the time of determination. In another example, the controller 10 sets the first airflow rate W1 to the value obtained by multiplying the first airflow rate W1 at the time of determination by a coefficient that is less than 1.

Further, the controller 10 determines whether the first airflow rate W1 is greater than or equal to the predetermined airflow rate. When the first airflow rate W1 is less than the predetermined airflow rate, the controller 10 sets the predetermined airflow rate to the first airflow rate W1.

The controller 10 sets the second airflow rate W2 based on the first airflow rate W1. Specifically, the controller 10 sets the second airflow rate W2 based on the required airflow rate WA and the first airflow rate W1 in the same manner as Example 1 of the first embodiment.

When the first energy consumption is less than or equal to the second energy consumption, the controller 10 sets the second airflow rate W2 such that the second energy consumption is less than or equal to its value at the time of determination. Specifically, the controller 10 sets the second airflow rate W2 such that it is less than or equal to the second airflow rate W2 at the time of determination. In one example, the controller 10 sets the second airflow rate W2 to the value obtained by subtracting the predetermined airflow rate from the second airflow rate W2 at the time of determination. In another example, the controller 10 sets the second airflow rate W2 to the value obtained by multiplying the second airflow rate W2 at the time of determination by a coefficient that is less than 1.

The controller 10 sets the first airflow rate W1 based on the second airflow rate W2. Specifically, the controller 10 sets the first airflow rate W1 based on the required airflow rate WA and the second airflow rate W2 in the same manner as Example 2 of the first embodiment.

### Advantages

The advantages of the present embodiment will now be described.

When the first energy consumption is greater than the second energy consumption, the controller 10 sets the first airflow rate WI to be greater than or equal to the predetermined airflow rate such that the first selected state quantity of the target space S satisfies the first criterion. Further, the controller 10 sets the second airflow rate W2 based on the first airflow rate W1.

In some situations, the first selected state quantity, which can be adjusted only by the outside air drawing device 2, needs to be adjusted and the drawing of outside air by the outside air drawing device 2 in the air conditioning for the target space S is disadvantageous in terms of energy consumption. In the above configuration, in such situations, the first airflow rate W1 for the outside air drawing device 2 is set to be greater than or equal to the predetermined airflow rate as described above. This achieves energy savings while performing air conditioning for the target space S such that the target substance concentration approaches the objective concentration and the first selected state quantity satisfies the first criterion.

### Eighth Embodiment

The air conditioning coordination system 1 according to an eighth embodiment will now be described with reference to FIG. 10. In the air conditioning coordination system 1 of the present embodiment, same reference characters are given to those elements that are the same as the corresponding elements of the first embodiment. Such elements will not be described in detail.

The air conditioning coordination system 1 of the present embodiment differs from the sixth embodiment in the following aspects. In the sixth embodiment, the first airflow rate W1 or the second airflow rate W2 is set based on the energy consumption. In the present embodiment, the first airflow rate W1 or the second airflow rate W2 is set based on the energy consumption and the second selected state quantity.

The air conditioning coordination system 1 adjusts the target substance concentration in the target space S through the coordination between the outside air drawing device 2 and the air treatment device 3. The target substance T is, for example, a pathogen. The second selected state quantity is the PM concentration. The air treatment device 3 includes the treatment unit 6A and the air conditioning unit 7, which adjusts the temperature in the target space S. The air treatment device 3 includes the additional treatment unit 6C, which is capable of treating the substance M related to the second selected state quantity.

Based on the determination result of whether the first energy consumption is greater than the second energy consumption, the controller 10 prioritizes setting either the first airflow rate W1 or the second airflow rate W2 first.

The controller 10 determines whether the first energy consumption is greater than the second energy consumption.

The controller 10 has a predetermined airflow rate for the air treatment device 3. This airflow rate is required to ensure that the second selected state quantity satisfies the second criterion in the target space S.

When the first energy consumption is greater than the second energy consumption, the controller 10 sets the first airflow rate W1 such that the first energy consumption is less than or equal to its value at the time of determination. Specifically, the controller 10 sets the first airflow rate W1 such that it is less than or equal to the first airflow rate W1 at the time of determination. In one example, the controller 10 sets the first airflow rate W1 to the value obtained by subtracting the predetermined airflow rate from the first airflow rate W1 at the time of determination. In another example, the controller 10 sets the first airflow rate W1 to the value obtained by multiplying the first airflow rate W1 at the time of determination by a coefficient that is less than 1.

The controller 10 sets the second airflow rate W2 based on the first airflow rate W1. Specifically, the controller 10 sets the second airflow rate W2 based on the required airflow rate WA and the first airflow rate W1 in the same manner as Example 1 of the first embodiment.

When the first energy consumption is less than or equal to the second energy consumption, the controller 10 sets the second airflow rate W2 to be greater than or equal to the predetermined airflow rate such that the second selected state quantity of the target space S satisfies the second criterion.

When the first energy consumption is less than or equal to the second energy consumption, the controller 10 sets the second airflow rate W2 such that the second energy consumption is less than or equal to its value at the time of determination. Specifically, the controller 10 sets the second airflow rate W2 such that it is less than or equal to the second airflow rate W2 at the time of determination. In one example, the controller 10 sets the second airflow rate W2 to the value obtained by subtracting the predetermined airflow rate from the second airflow rate W2 at the time of determination. In another example, the controller 10 sets the second airflow rate W2 to the value obtained by multiplying the second airflow rate W2 at the time of determination by a coefficient that is less than 1.

Further, the controller 10 determines whether the second airflow rate W2 is greater than or equal to the predetermined airflow rate. When the second airflow rate W2 is less than the predetermined airflow rate, the controller 10 sets the predetermined airflow rate to the second airflow rate W2.

The controller 10 sets the first airflow rate W1 based on the second airflow rate W2. Specifically, the controller 10 sets the first airflow rate W1 based on the required airflow rate WA and the second airflow rate W2 in the same manner as Example 2 of the first embodiment.

### Advantages

The advantages of the present embodiment will now be described.

When the first energy consumption is less than or equal to the second energy consumption, the controller 10 sets the second airflow rate W2 to be greater than or equal to the predetermined airflow rate such that the second selected state quantity of the target space S satisfies the second criterion. Further, the controller 10 sets the first airflow rate W1 based on the second airflow rate W2.

In some situations, the second selected state quantity, which can be configured only by the air treatment device 3, needs to be adjusted and operating the air treatment device 3 in the air conditioning for the target space S is disadvantageous in terms of energy consumption. In the above configuration, in such situations, the second airflow rate W2 for the air treatment device 3 is set to be greater than or equal to the predetermined airflow rate as described above. This achieves energy savings while performing air conditioning for the target space S such that the target substance concentration approaches the objective concentration and the second selected state quantity satisfies the second criterion.

### Modifications

In addition to the above-described embodiments, the air conditioning coordination system 1 of the present disclosure is applicable to, for example, modified examples of the above embodiment that are described below and combinations of at least two of the modified examples that do not contradict each other.

Regarding the present embodiment, a control device 20 configured, as follows, to solve the problem is disclosed (see FIGS. 1, 3 to 5, and 7 to 10). The control device 20 adjusts equipment that adjusts the air state of the target space S. The equipment includes the outside air drawing device 2, which adjusts the target substance concentration in the target space S by drawing outside air into the target space S, and the air treatment device 3 with the treatment unit 6, which adjusts the target substance concentration by treating the air in the target space S. The control device 20 refers to the required airflow rate WA and one of the first airflow rate W1 for the outside air drawing device 2 and the second airflow rate W2 for the air treatment device 3 to set the other one of the first airflow rate W1 and the second airflow rate W2. The first airflow rate W1 is the flow rate of air that is drawn into the target space S by the outside air drawing device 2. The second airflow rate W2 is the flow rate of air treated by the air treatment device 3.

In this configuration, when bringing the target substance concentration closer to the objective concentration, more energy is saved compared to when the outside air drawing device 2 and the air treatment device 3 operate independently.

Regarding the present embodiment, the control device 20 configured, as follows, to solve the problem is disclosed. The control device 20 adjusts equipment that adjusts the air state of the target space S. The equipment includes the outside air drawing device 2, which adjusts the target state quantity in the target space S by drawing outside air into the target space S, and the air treatment device 3 with the treatment unit 6, which adjusts the target state quantity by treating the air in the target space S. The control device 20 includes the memory 11 and the controller 10, which sets the first airflow rate W1 for the outside air drawing device 2 and the second airflow rate W2 for the air treatment device 3. The memory 11 stores relational information indicating the relationship between the first airflow rate W1, the second airflow rate W2, and the selected state quantity. The selected state quantity is a state quantity of the target space S that is different from the target state quantity and is changed by at least one of the outside air drawing device 2 and the air treatment device 3. The controller 10 sets the first airflow rate W1 and the second airflow rate W2 from the relational information based on the selected state quantity. In this configuration, when the target state quantity in the target space S is adjusted, more energy is saved compared to when the outside air drawing device 2 and the air treatment device 3 operate independently.

In the second embodiment, the relational information has been described. The relational information correlates the selected state quantity, the first airflow rate W1, and the second airflow rate W2 with each other. The relational information may have the following configuration. In Example 3-2 of the second embodiment, the relational information includes third relational information that indicates the relationship between the first selected state quantity, the first airflow rate W1, and the second airflow rate W2. In Example 3-2 of the second embodiment, in the relational information, the relationship between the first selected state quantity, the first airflow rate W1, and the second airflow rate W2 is set to ensure that the first selected state quantity of the target space S satisfies the first criterion. The example of this modification does not include the condition that the first selected state quantity of the target space S satisfies the first criterion. In the example of this modification, the relationship between the first selected state quantity, the first airflow rate W1, and the second airflow rate W2 is set based on a predetermined purpose. Examples of the predetermined purpose include comfort for business activities, comfort for relaxation, and optimal air conditioning with an emphasis on infection prevention. This configuration allows the first airflow rate W1 and the second airflow rate W2 to be derived based on the first selected state quantity and the third relational information.

In the third embodiment, the relational information has been described. The relational information correlates the selected state quantity, the first airflow rate W1, and the second airflow rate W2 with each other. The relational information of the third embodiment may have the following configuration. In the third embodiment, the relational information includes fourth relational information that indicates the relationship between the second selected state quantity, the first airflow rate W1, and the second airflow rate W2. In the example of this modification, the relationship between the second selected state quantity, the first airflow rate W1, and the second airflow rate W2 is set based on a predetermined purpose. Examples of the predetermined purpose include comfort for business activities, comfort for relaxation, and optimal air conditioning with an emphasis on infection prevention. This configuration allows the first airflow rate W1 and the second airflow rate W2 to be derived based on the second selected state quantity and the fourth relational information.

The relational information indicated in the first and second embodiments may take any form. In the first embodiment, the relationship between the first airflow rate W1 and the second airflow rate W2 may be constructed using a table format, formula, learning model, or chart. In the second or third embodiment, the relationship between the selected state quantity, the first airflow rate W1, and the second airflow rate W2 may be constructed using a table format, formula, learning model, or chart.

This specification discloses the following techniques.

[Clause 1] An air conditioning coordination system that adjusts an air state of a target space, the air conditioning coordination system including:
an outside air drawing device that adjusts a target substance concentration of the target space by drawing outside air into the target space;
an air treatment device including a treatment unit that adjusts the target substance concentration by treating air in the target space; and
a controller that sets a first airflow rate for the outside air drawing device and a second airflow rate for the air treatment device, where
the controller refers to a required airflow rate and one of the first airflow rate and the second airflow rate to set the other one of the first airflow rate and the second airflow rate, the required airflow rate being necessary to bring the target substance concentration to an objective concentration,
the first airflow rate is a flow rate of air that is drawn into the target space by the outside air drawing device, and
the second airflow rate is a flow rate of air treated by the air treatment device.

[Clause 2] The air conditioning coordination system according to clause 1, where
a state quantity that is different from the target substance concentration and is adjusted by drawing outside air using the outside air drawing device is defined as a first selected state quantity, and
the controller for the air conditioning coordination system sets the first airflow rate such that the first selected state quantity of the target space satisfies a first criterion and sets the second airflow rate based on the first airflow rate.

[Clause 3] The air conditioning coordination system according to clause 2, where
the controller has an airflow rate range that is set such that the first selected state quantity satisfies the first criterion, and
the controller sets the first airflow rate to a minimum amount of the airflow rate range set for the first selected state quantity of the target space.

[Clause 4] The air conditioning coordination system according to clause 1, where
a state quantity that is different from the target substance concentration and is removed through air treatment performed by the air treatment device is defined as a second selected state quantity, and
the controller for the air conditioning coordination system sets the second airflow rate such that the second selected state quantity of the target space satisfies a second criterion and sets the first airflow rate based on the second airflow rate.

[Clause 5] The air conditioning coordination system according to clause 2, where
the first selected state quantity is a carbon dioxide concentration in the target space.

[Clause 6] The air conditioning coordination system according to clause 2, where
the air treatment device includes an air purifier including the treatment unit and an air conditioner including the treatment unit and an air conditioning unit that adjusts a temperature in the target space,
the second airflow rate includes an airflow rate for the air purifier and an airflow rate for the air conditioner, and
the first selected state quantity is a carbon dioxide concentration in the target space.

[Clause 7] The air conditioning coordination system according to clause 6, where
an airflow rate treated by the treatment unit in the air purifier is defined as a third airflow rate,
an airflow rate treated by the air conditioning unit and the treatment unit in the air conditioner and set based on a temperature in the target space is defined as a fourth airflow rate, and
the controller for the air conditioning coordination system sets the third airflow rate based on the second airflow rate and the fourth airflow rate.

[Clause 8] The air conditioning coordination system according to clause 2, where
the first selected state quantity is a temperature or humidity in the target space.

[Clause 9] The air conditioning coordination system according to clause 1, where
when a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption,
when a unit amount of air in the target space is treated, an energy consumption of the air treatment device required to treat the unit amount of air is defined as a second energy consumption,
the air treatment device of the air conditioning coordination system includes the treatment unit and an air conditioning unit that adjusts the temperature in the target space,
the controller determines whether the first energy consumption is greater than the second energy consumption,
when the first energy consumption is greater than the second energy consumption, the controller sets the first airflow rate such that the first energy consumption is less than or equal to a value at a time of determination, and sets the second airflow rate based on the first airflow rate, and
when the first energy consumption is less than or equal to the second energy consumption, the controller sets the second airflow rate such that the second energy consumption is less than or equal to a value at a time of determination, and sets the first airflow rate based on the second airflow rate.

[Clause 10] The air conditioning coordination system according to clause 1, where
when a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption,
when a unit amount of air in the target space is treated, an energy consumption of the air treatment device required to treat the unit amount of air is defined as a second energy consumption,
a state quantity that is different from the target substance concentration and is adjusted by drawing the outside air using the outside air drawing device is defined as a first selected state quantity,
the controller for the air conditioning coordination system has a predetermined airflow rate for the outside air drawing device, the predetermined airflow rate being required to ensure that the first selected state quantity satisfies the first criterion in the target space,
the air treatment device includes the treatment unit and an air conditioning unit that adjusts the temperature in the target space, and
when the first energy consumption is greater than the second energy consumption, the controller sets the first airflow rate to be greater than or equal to the predetermined airflow rate such that the first selected state quantity of the target space satisfies the first criterion, and sets the second airflow rate based on the first airflow rate.

[Clause 11] The air conditioning coordination system according to clause 1, where
when a unit amount of outside air is drawn in the target space, a total of an energy consumption of the outside air drawing device required for drawing the outside air in and an energy consumption of the air treatment device required to return a temperature in the target space, into which the unit amount of the outside air has been drawn, back to a temperature the target space has before the outside air was drawn in is defined as a first energy consumption,
when a unit amount of air in the target space is treated, an energy consumption of the air treatment device required to treat the unit amount of air is defined as a second energy consumption,
a state quantity that is different from the target substance concentration and is adjustable through air treatment performed by the air treatment device is defined as a second selected state quantity,
the controller for the air conditioning coordination system has a predetermined airflow rate for the air treatment device, the predetermined airflow rate being required to ensure that the second selected state quantity satisfies the second criterion in the target space,
the air treatment device includes the treatment unit and an air conditioning unit that adjusts the temperature in the target space, and
when the first energy consumption is less than or equal to the second energy consumption, the controller sets the second airflow rate to be greater than or equal to the predetermined airflow rate such that the second selected state quantity of the target space satisfies the second criterion, and sets the first airflow rate based on the second airflow rate.

[Clause 12] The air conditioning coordination system according to any one of clauses 1 to 11, where
the target substance concentration is a pathogen concentration, a pollen concentration, a PM concentration, a dust concentration, or a hazardous chemical concentration in the target space.

[Clause 13] A control device that controls equipment that adjusts an air state of a target space, where
the equipment includes:
   an outside air drawing device that adjusts a target substance concentration of the target space by drawing outside air into the target space; and
   an air treatment device including a treatment unit that adjusts the target substance concentration by treating air in the target space,
the control device refers to a required airflow rate and one of a first airflow rate for the outside air drawing device and a second airflow rate for the air treatment device to set the other one of the first airflow rate and the second airflow rate, the required airflow rate being necessary to bring the target substance concentration to an objective concentration,
the first airflow rate is a flow rate of air that is drawn into the target space by the outside air drawing device, and
the second airflow rate is a flow rate of air treated by the air treatment device.

While the embodiments of the air conditioning coordination system 1 have been described herein above, it is to be appreciated that various changes in form and detail may be made without departing from the spirit and scope of the air conditioning coordination system 1 presently or hereafter claimed.

1. An air conditioning coordination system that adjusts an air state of a target space, the air conditioning coordination system comprising:
an outside air drawing device that adjusts a target state quantity of the target space by drawing outside air into the target space;
an air treatment device including a treatment unit that adjusts the target state quantity by treating air in the target space;
a controller that sets a first airflow rate for the outside air drawing device and a second airflow rate for the air treatment device; and
a memory that stores relational information indicating a relationship between the first airflow rate, the second airflow rate, and a selected state quantity, the selected state quantity being a state quantity of the target space that is different from the target state quantity and being changed by at least one of the outside air drawing device and the air treatment device, wherein
the controller sets the first airflow rate and the second airflow rate from the relational information based on the selected state quantity,
the first airflow rate is a flow rate of air that is drawn into the target space by the outside air drawing device, and
the second airflow rate is a flow rate of air treated by the air treatment device.

2. The air conditioning coordination system according to claim 1, wherein
the selected state quantity includes a first selected state quantity that is changed by the outside air drawing device, and
the relational information includes:
first derivation information used to derive the first airflow rate based on the first selected state quantity; and
second derivation information used to derive the second airflow rate based on the first airflow rate.

3. The air conditioning coordination system according to claim 2, wherein
the controller has an airflow rate range that is set such that the first selected state quantity satisfies a first criterion, and
the controller sets the first airflow rate to a minimum amount of the airflow rate range set for the first selected state quantity of the target space.

4. The air conditioning coordination system according to claim 3, wherein
the first selected state quantity is a carbon dioxide concentration, temperature, or humidity in the target space.

5. The air conditioning coordination system according to claim 2, wherein
the air treatment device includes:
an air purifier including the treatment unit; and
an air conditioner including the treatment unit and an air conditioner that adjusts a temperature in the target space, and
the second airflow rate includes an airflow rate for the air purifier and an airflow rate for the air conditioner.

6. The air conditioning coordination system according to claim 1, wherein
the selected state quantity includes a second selected state quantity that is removed through air treatment performed by the air treatment device, and
the relational information includes:
third derivation information used to derive the second airflow rate based on the second selected state quantity; and
fourth derivation information used to derive the first airflow rate based on the second airflow rate.

7. The air conditioning coordination system according to claim 1, wherein
the selected state quantity includes a first selected state quantity that is changed by the outside air drawing device, and
the relational information includes third relational information that indicates a relationship between the first selected state quantity, the first airflow rate, and the second airflow rate.

8. The air conditioning coordination system according to claim 1, wherein
the selected state quantity includes a second selected state quantity that is removed through air treatment performed by the air treatment device, and
the relational information includes fourth relational information that indicates a relationship between the second selected state quantity, the first airflow rate, and the second airflow rate.

9. The air conditioning coordination system according to claim 1, wherein
the target state quantity is a pathogen concentration, a pollen concentration, a PM concentration, a dust concentration, or a hazardous chemical concentration in the target space.

10. A control device that controls equipment that adjusts an air state of a target space, wherein
the equipment includes:
an outside air drawing device that adjusts a target state quantity of the target space by drawing outside air into the target space; and
an air treatment device including a treatment unit that adjusts the target state quantity by treating air in the target space,
the control device comprises:
a controller that sets a first airflow rate for the outside air drawing device and a second airflow rate for the air treatment device; and
a memory that stores relational information indicating a relationship between the first airflow rate, the second airflow rate, and a selected state quantity, the selected state quantity being a state quantity of the target space that is different from the target state quantity and being changed by at least one of the outside air drawing device and the air treatment device, wherein
the controller sets the first airflow rate and the second airflow rate from the relational information based on the selected state quantity,
the first airflow rate is a flow rate of air that is drawn into the target space by the outside air drawing device, and
the second airflow rate is a flow rate of air treated by the air treatment device.

11. The air conditioning coordination system according to claim 2, wherein
the target state quantity is a pathogen concentration, a pollen concentration, a PM concentration, a dust concentration, or a hazardous chemical concentration in the target space.

12. The air conditioning coordination system according to claim 3, wherein
the target state quantity is a pathogen concentration, a pollen concentration, a PM concentration, a dust concentration, or a hazardous chemical concentration in the target space.

13. The air conditioning coordination system according to claim 4, wherein
the target state quantity is a pathogen concentration, a pollen concentration, a PM concentration, a dust concentration, or a hazardous chemical concentration in the target space.

14. The air conditioning coordination system according to claim 5, wherein
the target state quantity is a pathogen concentration, a pollen concentration, a PM concentration, a dust concentration, or a hazardous chemical concentration in the target space.

15. The air conditioning coordination system according to claim 6, wherein
the target state quantity is a pathogen concentration, a pollen concentration, a PM concentration, a dust concentration, or a hazardous chemical concentration in the target space.

16. The air conditioning coordination system according to claim 7, wherein
the target state quantity is a pathogen concentration, a pollen concentration, a PM concentration, a dust concentration, or a hazardous chemical concentration in the target space.

17. The air conditioning coordination system according to claim 8, wherein
the target state quantity is a pathogen concentration, a pollen concentration, a PM concentration, a dust concentration, or a hazardous chemical concentration in the target space.
